(19) United States
(12) Patent Application Publication
(10) Pub. No.: US 2026/0338324 A1
(43) Pub. Date: Oct. 29, 2026

(54) GYROSTABILISER ASSEMBLY

(71) Applicant: VEEM LTD, Canning Vale (AU)

(72) Inventor: Andrey Vladimirovich BEKKER, Canning Vale (AU)

(21) Appl. No.: 19/116,169

(22) PCT Filed: Sep. 27, 2023
(86) PCT No.: PCT/AU2023/050936

§ 371 Date: Mar. 27, 2025

(30) Foreign Application Priority Data
Sep. 27, 2022 (AU) 2022902800

(51) Int. Cl. F16N 7/40; B63B 39/04; B66C 13/06; F16N 13/20; F16N 17/06

(52) U.S. Cl. CPC F16N 7/40; B63B 39/04; B66C 13/06; F16N 13/20; F16N 17/06; F16N 2210/14

(57) ABSTRACT

The disclosure relates to a gyrostabiliser assembly for a marine vessel comprising: a housing defining a chamber for supporting at least a partial vacuum; a flywheel mounted within the chamber for rotation about a spin axis; a flywheel shaft on which the flywheel is mounted in the housing for rotation of the flywheel about the spin axis, the flywheel shaft rotatably supported by a first and second spin bearing; and a lubrication system for circulating a liquid lubricant to the first and second bearings from a lubricant sump or reservoir. The reservoir is arranged in or on the housing to collect lubricant from the bearings under gravity and the first and second bearings are arranged in the housing for operation under the partial vacuum. The lubrication system includes a rotary disc pump coupled to and driven by the flywheel shaft for circulating the lubricant to the first and second bearings.

### CROSS REFERENCE TO RELATED APPLICATIONS

The present application is a U.S. National Phase of International Application No. PCT/AU2023/050936 entitled “GYROSTABILISER ASSEMBLY,” and filed on Sep. 27, 2023. International Application No. PCT/AU2023/050936 claims priority to Australian Patent Application No. 2022902800 filed on Sep. 27, 2022. The entire contents of each of the above-listed applications are hereby incorporated by reference for all purposes.

### TECHNICAL FIELD

The present disclosure relates to a gyrostabiliser assembly, and particularly to a gyrostabiliser assembly having an improved bearing lubrication system.

The gyrostabiliser assembly of the disclosure will typically be designed for use in a marine vessel and it will be convenient to describe it in this exemplary context. It will be appreciated, however, that the gyrostabiliser assembly of the disclosure is not limited to that particular application and may be designed for use in many other applications, such as in other fixed and floating structures, other vehicles, hoisting systems, and/or in camera mountings.

### BACKGROUND

The discussion of background art in this specification, including with reference to any documents, should in no way be considered an admission that such background art is well known or forms part of the common general knowledge in the field in Australia or in any other country.

The structure and operation of marine gyrostabiliser assemblies are generally quite well understood and these devices are gaining increasing adoption in commercial and recreational marine vessels. A gyrostabiliser assembly will typically comprise a spinning flywheel mounted in a gimbal frame that allows rotational degrees of freedom, and the gimbal frame is rigidly mounted within the vessel. The specific way in which the flywheel is constrained in rotational motion allows the angular momentum of the spinning flywheel to combine with the flywheel's precession oscillation to generate large torques that vary with time to directly oppose a dynamic rolling motion of the vessel caused by wind and/or waves. Without any intervention, the vessel's rolling motion combines with the flywheel angular momentum to cause oscillating precession motion. This then combines with the angular momentum to create a stabilising torque, which directly opposes undesirable rotational motion (e.g., wave-induced rolling motion) of the vessel. By arranging the gimbals in a specific way, a roll-stabilising device is created using the naturally occurring physics of gyro-dynamics which then requires no further intervention to function. An example of a marine gyrostabiliser assembly is described in the present applicant's Australian patent application AU 2017216483 A1, the contents of which are incorporated herein in their entirety by direct reference.

Due to the high velocity of an outer rim of the flywheel in a gyrostabiliser, the gimbal frame will often comprise a chamber enclosing the flywheel that is evacuated to enable the flywheel to spin within a vacuum. This reduces the aerodynamic drag on the flywheel, reducing power required to maintain the flywheel speed (rpm). It also reduces heat generated by air resistance to the spinning flywheel rim, which in turn improves efficiency. The spin bearings that are used to locate and hold the flywheel about a spin axis are subject to both high loads and high rotational speeds which also generate heat and noise. The spin bearings and spin motor are typically located within the vacuum chamber to avoid issues associated with sealing the vacuum chamber where the spin shaft exits the vacuum chamber. However, having the spin bearings inside the vacuum chamber can make it difficult to lubricate those bearings, as well as to cool the bearings. It can be particularly difficult to cool an inner part of the spin bearings and the flywheel shaft because these are rotating and cannot easily be cooled via contact with a coolant jacket.

The co-pending Australian patent application AU 2017216483 A1 describes an arrangement having an oil lubrication system for lubricating and cooling the bearings, with which an oil flowrate to the bearings can be selected to provide both lubrication and an exchange of heat generated by the bearings into the oil. The oil lubrication system is desirable for reduced noise, extended bearing life, and the ability to remove heat from inner part of the bearings. In this system, the oil is drawn from a sump by one or more scavenge pumps. To allow the scavenge pumps to operate, the arrangement separates an upper bearing chamber and a lower bearing chamber from the vacuum chamber that encloses the flywheel by rotary shaft seals on the flywheel shaft. One seal is below the upper bearing chamber and the other seal is above the lower bearing chamber, with the upper and lower bearing chambers manifolded together by drain lines between them. With this arrangement, the flywheel can spin in a partial- or near-vacuum at sufficiently low pressure that air resistance is substantially reduced or eliminated, while the bearing-housings (which are manifolded so that they operate at the same pressure) are able to operate at a sufficiently high pressure for the scavenge pumps to pump the oil to the spin bearings effectively.

However, the arrangement described in AU 2017216483 A1 has disadvantages in that it requires a dual vacuum pressure management system for the vacuum chamber and the bearing chambers, and in that the rotary shaft seal components are subject to rotational resistance from the high contact surface velocities, which leads to wear and to associated costs of maintenance and/or later replacement, as well as to higher power requirements to maintain the desired flywheel speeds (rpm).

To address these concerns, the present applicant developed new gyrostabiliser arrangements in which rotary shaft seals separating or isolating the spin bearings from the operating pressure of the flywheel chamber are not required. An example of such a gyrostabiliser assembly is described in the applicant's international patent application PCT/AU2021/050197, published as WO 2021/174315 A1, the contents of which are incorporated herein in their entirety by direct reference. This new arrangement has the advantage that it removes a need for a dual vacuum pressure management system and simplifies the arrangement by reducing the number of components and the points of possible failure, thereby making the gyrostabiliser assembly more reliable and robust. It has been found, however, that problems with lubrication of the bearings generally, and with the circulation of the lubricant oil in particular, may be encountered when operating pressure of the flywheel chamber is a rough vacuum of about 0.1 bar or less (absolute pressure). The pressure values presented herein are absolute pressure values unless stated otherwise.

It would therefore be desirable to provide a new gyrostabiliser arrangement that substantially overcomes or ameliorates one or more of the above disadvantages. In this regard, it would be desirable to provide a new gyrostabiliser assembly with a lubrication system that can reliably lubricate and cool the bearings when operating in a rough or partial vacuum.

### SUMMARY

According to one broad aspect, the present disclosure provides a gyrostabiliser assembly comprising:
a housing defining a chamber for supporting an operating pressure;
a flywheel mounted within the chamber for rotation about a spin axis at the operating pressure;
a flywheel shaft on which the flywheel is mounted in the housing supported by a first spin bearing and second spin bearing located at opposite end regions of the shaft for rotation of the flywheel about the spin axis, wherein the first and the second spin bearings are arranged in the housing for use at the operating pressure; and
a bearing lubrication system comprising a lubricant circuit for circulating a liquid lubricant to the first and second spin bearings from a lubricant sump or reservoir that is located or arranged to collect the liquid lubricant from the first and second spin bearings under gravity, wherein the bearing lubrication system includes a pump provided in the sump or reservoir which is coupled to and driven by the flywheel shaft for circulating the lubricant in the lubricant circuit.

In an embodiment, the pump comprises a rotary disc pump, which is a kind of centrifugal pump, having an impeller comprising at least one substantially flat disc, and preferably two (or more) substantially flat discs mounted in a spaced, generally parallel arrangement with respect to one another. The impeller is typically without vanes and, when rotated, takes advantage of the principles of boundary layer and viscous drag to impel the liquid lubricant (e.g., oil) from the sump or reservoir along the lubricant circuit. As the impeller of the rotary disc pump is preferably designed without vanes it can be rotated at very high speed with substantially laminar flow of the lubricant and without generating significant vibration or cavitation. The rotary disc pump is preferably a closed rotary disc pump. It preferably includes a first solid (e.g., flat or plain) disc mounted in uniform spaced relation to at least a second, axially aligned (e.g., flat or plain) annular disc of substantially the same outer diameter as the first disc. The central opening in the annular disc allows central flow or passage of the oil into the impeller and into the space between the discs. This pump or “pump means” in the sump or reservoir may be considered a “return pump” for returning the lubricant from the reservoir back into the lubricant circuit.

In an embodiment of the disclosure, the rotary disc pump includes a plurality of axially aligned annular discs, preferably of substantially the same outer diameter as the first disc. The plurality of annular discs may be mounted in a stacked array above the first disc, preferably substantially uniformly spaced apart in relation to each other and/or in relation to the first disc. The central opening in each of the annular discs is also desirably substantially uniform and again allows central flow or passage of the oil into the impeller and into the space between each of the discs. For example, the impeller may include two, three, four, or five annular discs mounted in a stacked array in combination with a solid disc. With a plurality of annular discs combined with (at least) one solid disc, the pressure head generated by the pump and the efficiency of the pump can be substantially improved compared to a single annular disc. The improvements in pressure head and efficiency tend to become smaller once the number of discs exceeds five, however. Desirably, the number of discs provided in the impeller is in the range of two to eight, and preferably five. Each plain or flat annular disc preferably has a radial width in a range of about 20% to about 40% of an outer diameter of the disc. The central aperture of the annular disc thus preferably has a diameter in a range of about 20% to about 60% of the outer diameter of the disc. More preferably, a radial width of each annular disc is in a range of about 25% to about 30% of the outer diameter of the disc. As such, the central aperture of the annular disc will more preferably have a diameter that is in a range of about 40% to about 50% of the outer diameter of the disc. Each disc preferably has a thickness in a range of about 0.5% to about 2% of the outer diameter of the disc.

In an embodiment of the disclosure, a spacing between each of the discs of the impeller is preferably in a range of 0.2 mm to 5.0 mm, more preferably in a range of 0.2 mm to 2.0 mm, and even more preferably in a range of 0.2 mm to 1.5 mm; particularly preferably 0.5 mm. A thickness of each of the discs is preferably in the range of 0.5 mm to 2.0 mm, with an outer diameter of the discs preferably being in a range of about 100 mm to about 200 mm, and more preferably in a range of about 100 mm to about 150 mm, e.g., a diameter of about 120 mm. The distance between an uppermost disc of the impeller and a top casing plate of the housing is in a range of 0.05 mm to 0.2 mm. Pins or bolts that interconnect the discs of the impeller preferably have an elliptical cross-sectional profile (e.g., in a ratio of 1:2) thereby presenting a low profile in a direction of rotation of the impeller (i.e., with the shorter elliptical dimension parallel to the radius of the discs).

In an embodiment, the impeller of the rotary disc pump is directly coupled to the flywheel shaft for rotation therewith (i.e., in the absence of gearing). In this way, the impeller of the pump may be rotated with the gyro flywheel shaft at speeds in the range of about 3,000 rpm to about 10,000 rpm. Due to the low hydrodynamic resistance of the impeller, the pump does not require gearing and the high rotational speeds do not lead to excessive wear or any significant cavitation effects in the lubricant.

In this way, the gyrostabiliser assembly of the present disclosure is able to take advantage of the simpler structural arrangement without rotary shaft seals separating or isolating the spin bearings from the operating pressure of the flywheel chamber, as is described in WO 2021/174315 A1, and still produce effective lubrication and cooling of the gyrostabiliser spin bearings via the lubricant which is scavenged and pumped at a rough vacuum operating pressure less than 0.5 bar, preferably less than 0.2 bar, and more preferably in a range of about 1 mbar to 100 mbar (absolute pressure). The rotary disc pump is largely able to avoid cavitation issues at the rough vacuum pressures present in the vacuum chamber and is also effective with ‘splashing’ inlet conditions at the pump, which can arise in a heavily ‘precessing’ vacuum chamber.

In an embodiment, either or both of the first spin bearing and the second spin bearing include(s) a lubricant labyrinth, e.g., provided around it or them. In this regard, the labyrinth of the first (upper) spin bearing desirably operates to prevent the lubricant (oil) that has been applied to and has flowed through that first bearing from flowing onto the flywheel. (This would waste power if the oil were dragged along the chamber wall by the spinning flywheel). The labyrinth of the second (lower) spin bearing desirably acts to keep the lubricant (oil) that has been applied to and has flowed through that bearing off the thrust bearing, which will typically have its own supply of cooling oil. The lubricant labyrinths redirect the cooling lubricant to the sump or reservoir via channels designed for this purpose. The sump or reservoir is configured and arranged in or on the housing so that the lubricant supplied, circulated, and/or delivered to the first and second spin bearings drains out of each respective bearing for return to the reservoir under gravity. In this regard, it is understood that the liquid lubricant is typically oil, such as a synthetic oil. In this regard, the lubrication oil will preferably have a vapour pressure less than 40 mbar at 80 °C.

It will be appreciated that the term “spin bearing” used throughout this document is understood as a reference to a bearing designed to mount or support the flywheel shaft for rotation, preferably free rotation, about the spin axis. As such, the term “spin bearing” will be understood as a rotary bearing and will include a range of rotary bearing designs, including a hydrodynamic bearing and a rolling-element bearing.

In an embodiment, the first and second spin bearings are configured as rolling-element bearings; e.g., with an inner race for the rolling elements rigidly attached to the flywheel shaft for rotation with the shaft and an outer race rigidly secured with respect to the housing. In an alternative embodiment, the first and second spin bearings may be configured as plain bearings; e.g., plain hydrodynamic bearings.

In an embodiment, the operating pressure is an at least partial vacuum such that the chamber within which the flywheel is mounted forms a vacuum chamber. This reduces aerodynamic drag on the flywheel, thereby reducing power required to maintain flywheel speed (rpm) while reducing heat generated by air resistance to the spinning flywheel. In this way, the whole vacuum chamber in the gyrostabiliser assembly forms a single chamber operating at one vacuum pressure. As noted above, operating pressure is preferably less than or equal to about 0.2 bar, preferably in a range of 1 to 100 mbar.

In an embodiment, the lubricant circuit, via which the lubricant is circulated from the sump or reservoir to the bearings and then back to the sump or reservoir, preferably includes a further pump external to the housing and vacuum chamber as a start-up, shutdown, and/or a “pressure boost” pump. This external pump may be called a “supply pump” and is preferably a vane pump or a positive displacement pump and is preferably magnetically coupled to a brushless electrical motor.

In an embodiment, the bearing lubrication system includes at least one lubricant delivery outlet, especially a lubricant jetting outlet, for targeted delivery or injection of the oil lubricant at each of the first and second bearings. The bearing lubrication system may thus have an ‘oil jet’ system. The oil flowrate is desirably selected to provide or to allow a desired exchange of heat generated at the bearings into the oil. The injection of oil via the jetting outlets ensures that the oil can be targeted at the inner race of each bearing and/or at rolling elements or sliding elements therein to provide effective cooling to these parts. The pump or “pump means” provided in the reservoir for delivering the lubricant (i.e., oil) from the reservoir to the first and second spin bearings is therefore preferably designed such that it can prime and deliver the necessary pressure to drive the oil with the required speed through the oil delivery outlets. In this regard, the pump or “pump means” may comprise a single pump stage or more than one pump stage. By carefully selecting or designing the pump means to deliver the required pressure and flow, the pump means can be arranged and sized to meet the required conditions for circulating the oil through one or more filters and/or one or more heat exchangers in the oil circuit, and then through the oil delivery outlets.

As noted above, the lubrication system may also form a cooling system for the spin bearings. As such, the liquid lubricant (i.e., oil) typically acts as a coolant to carry heat away from the first and second spin bearings. To this end, the lubricant circuit of the bearing lubrication system may include one or more heat exchanger for removing heat from the oil before the oil is delivered to the first and second spin bearings. In this regard, walls of the oil labyrinths may form a heat sink or heat exchanger for the oil. Alternatively, or in addition, the walls of the flywheel housing and/or the walls of the sump or reservoir may form a heat sink or heat exchanger for the oil, optionally via a cooling medium provided in those walls (e.g., a water jacket) of the housing or sump, and/or optionally via fin elements formed in the walls, as the oil returns to the reservoir under gravity and/or is circulated to the spin bearings from the reservoir. This heat may then be discharged (e.g., overboard) as heated cooling water. It is noted that deaeration of the oil is not required in the gyrostabiliser assembly of the disclosure because the air concentration in the oil at absolute pressures of 1-30 mbar is exceptionally low. This is beneficial as it simplifies the oil handling in the lubrication circuit and helps ensure that the delivery outlets function to provide a directed jet with sufficient velocity to break into the boundary layer to provide the necessary mixing and heat transfer. But the oil will usually be filtered prior to re-injection.

In an embodiment, the lubricant circuit includes an oil accumulator for storing oil and maintaining the oil pressure for cushioning fluctuations in the oil pressure from the pump. The oil accumulator may thus support the jet pressure for oil splashing conditions at the pump and/or for a period of time when oil supply may be absent at the pump inlet to the sump pump—for example, when the gyrostabiliser may be stuck for an extended period (e.g., 2 minutes) at a high precession angle (e.g., 70°) during a U-turn of the vessel. The oil accumulator is preferably a bladder- or piston-type oil accumulator. The oil pressure maintained by the oil accumulator in the lubricant circuit is preferably in the range of about 1.2 bar to about 3.2 bar. A non-return valve (check valve) is preferably located upstream of the oil accumulator to prevent exertion of a back-pressure from the oil accumulator on the sump or reservoir.

Both horizontal and vertical orientations of the flywheel shaft are contemplated for the gyroscope assembly of the present disclosure, and each provides challenges for lubrication in terms of getting the lubricant (e.g., oil) to the respective spin bearings and then recovering the lubricant for re-application.

In a preferred embodiment, the flywheel shaft is mounted in a generally vertical orientation within the housing for rotation about a generally vertical spin axis. The first and second bearings therefore form an upper spin bearing and a lower spin bearing, respectively. In such a configuration, the gyroscope assembly of the disclosure typically includes a further lower spin bearing (i.e., a third spin bearing) as a thrust bearing that provides axial support for the flywheel and the flywheel shaft. A vertical flywheel shaft orientation is preferred as this allows the housing to be set up as a pendulum having a natural point of stability near vertical. This means that no extra mechanism is required to ensure that a precession angle of the gyroscope assembly remains ‘centred’ around a mid-stroke. The oil returning from the upper and lower bearings is thus directed to a common reservoir or sump at a lower region or base of the housing and vacuum chamber. The oil in the reservoir/sump is then scavenged and (re-)circulated by the rotary disc pump located in the reservoir/sump.

In an embodiment, the pump or “pump means” in the sump or reservoir of the bearing lubrication system includes a two-stage pump arrangement to increase pump outlet pressure. In such a pump arrangement, the rotary disc pump preferably forms a first stage and a second stage preferably comprises a vaned/bladed centrifugal pump.

In an embodiment, the gyrostabiliser assembly comprises an electric motor for driving rotation of the flywheel about the spin axis. In one embodiment, the spin motor is mounted within the chamber. In an alternative embodiment, the spin motor is mounted outside of the chamber and is coupled to the flywheel shaft via either an isolated magnetic coupling or a sealed shaft connection. The magnetic coupling is preferred to avoid the need for a rotary shaft seal. If a shaft connection is required to a spin motor mounted outside of the chamber, this will again require a rotary shaft seal. An advantage here, however, is that this arrangement is decoupled from the large radial movement (runout) of the flywheel shaft, whereby the runout makes it difficult to seal effectively. Further, the shaft connecting the spin motor to the flywheel shaft only needs to transmit a relatively small spin torque and can therefore be relatively small in diameter. This, in turn, limits the seal contact surface velocities (reduced circumference at a given rpm leads to lower velocities), which substantially extends the possible rpm before the seal capacity becomes limiting, and reduces the rotational resistance of the seal. By contrast, in the current arrangement the rotary shaft seals are provided on the flywheel shaft that must withstand the full gyro-torque fully reversing at each rpm cycle. The shaft diameter and circumference are thus much greater, leading to higher contact surface velocities, higher wear, and technical challenges with extended seal life.

According to another aspect, the disclosure provides a gyrostabiliser assembly for a marine vessel comprising: a housing defining a chamber for supporting at least a partial vacuum; a flywheel mounted within the chamber for rotation about a spin axis at the partial vacuum; a flywheel shaft upon which the flywheel is supported or mounted in the housing for rotation of the flywheel about the spin axis, the flywheel shaft being rotatably supported by a first rotary bearing located at one end region of the shaft and a second rotary bearing located at an opposite end region of the shaft; and a bearing lubrication system configured to supply lubricant to the rotary bearings from a lubricant reservoir via a lubricant circuit. The first and second rotary bearings are arranged in the housing either under the partial vacuum or for operation under the partial vacuum (e.g., if the vacuum were applied only in use). The lubrication system includes a rotary disc pump in the reservoir for pumping or circulating the lubricant via the lubricant circuit.

In an embodiment of the gyrostabiliser assembly of the disclosure, the rotary disc pump in the reservoir is coupled to and driven by the flywheel shaft. Alternatively, however, the rotary disc pump may be separate from (i.e., not coupled to) the flywheel shaft and driven by a separate electric motor. As explained above, the rotary disc pump is a kind of centrifugal pump with an impeller comprising at least one substantially flat disc, and desirably two (or more) substantially flat discs mounted in a spaced, generally parallel arrangement with respect to one another. The impeller is typically without vanes and can be rotated at high speed with substantially laminar flow of the lubricant and without generating significant vibration or cavitation. The rotary disc pump is preferably a closed rotary disc pump. It preferably includes a first solid flat disc mounted in uniform spaced relation to a second, axially aligned annular flat disc of substantially the same outer diameter as the first disc.

Because, as noted above, the structure and operation of marine gyrostabilisers are generally quite well-understood, this specification does not aim to provide a detailed description of all of the components of a gyrostabiliser assembly, such as the flywheel, flywheel shaft, gimbal bearings, or the like. Rather, this specification directs the skilled reader to other publications for a description or explanation of those components.

According to another aspect, the present disclosure provides a marine vessel, such as a boat, that includes or incorporates a gyrostabiliser assembly of the disclosure according to any one of the embodiments described above. The gyrostabiliser assembly is typically firmly secured to a hull of the vessel, for example, adjacent a keel.

According to a further aspect, the disclosure provides a hoisting system, e.g., for use with a crane, that includes a gyrostabiliser assembly of the disclosure according to any of the embodiments described above. In this context, the gyrostabiliser assembly is designed or adapted to be suspended with a load from the hoisting system to dampen or suppress undesirable oscillatory rotation, e.g., caused by wind gusts, of a suspended load during a hoisting operation. At least one gyrostabiliser assembly is desirably provided for, and/or mounted along, each axis of required stabilisation.

It will be appreciated that the term “gyrostabiliser assembly” as used throughout this document is understood as referring to a gyrostabiliser apparatus or gyrostabiliser unit which may be incorporated or installed in a vehicle, such as a marine vessel, or in some other device subject to undesirable rotational motions (like wave-induced rolling motion) in order to counteract and/or reduce such undesirable motions.

### BRIEF DESCRIPTION OF THE DRAWINGS

For a more complete understanding of the invention and advantages thereof, exemplary embodiments of the invention are explained in more detail in the following description with reference to the accompanying drawing figures, in which like reference signs designate like parts and in which:

FIG. 1 is a schematic diagram of a gyrostabiliser assembly according to a preferred embodiment;

FIG. 2 is a schematic perspective view of the impeller of the rotary disc pump for the sump or reservoir of the gyrostabiliser assembly in the embodiment;

FIG. 3 is a schematic cross-sectional side view of the impeller of the rotary disc pump provided in the sump or reservoir in the gyrostabiliser assembly;

FIG. 4 is a chart illustrating variation in pump efficiency and outlet head or pressure of the rotary disc pump with variation in the number of the discs in the impeller;

FIG. 5 is a schematic cross-sectional view of a hull of a marine vessel that includes a gyrostabiliser assembly according to an embodiment of the disclosure; and

FIG. 6 is a schematic view of a hoisting system that includes a gyrostabiliser assembly according to an embodiment of the disclosure.

The accompanying drawings are included to provide a further understanding of the present invention and are incorporated in and constitute a part of this specification. The drawings illustrate particular embodiments of the invention and, together with the description, serve to explain the principles of the invention. Other embodiments of the invention and many of the attendant advantages will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. Furthermore, it will be noted that the elements of the drawings are not necessarily illustrated to scale relative to each other. It will also be understood that certain actions or steps in an embodiment of a method may be described or depicted in a particular order of occurrences while those skilled in the art will understand that such specificity with respect to sequence is not actually required.

### DETAILED DESCRIPTION OF THE EMBODIMENTS

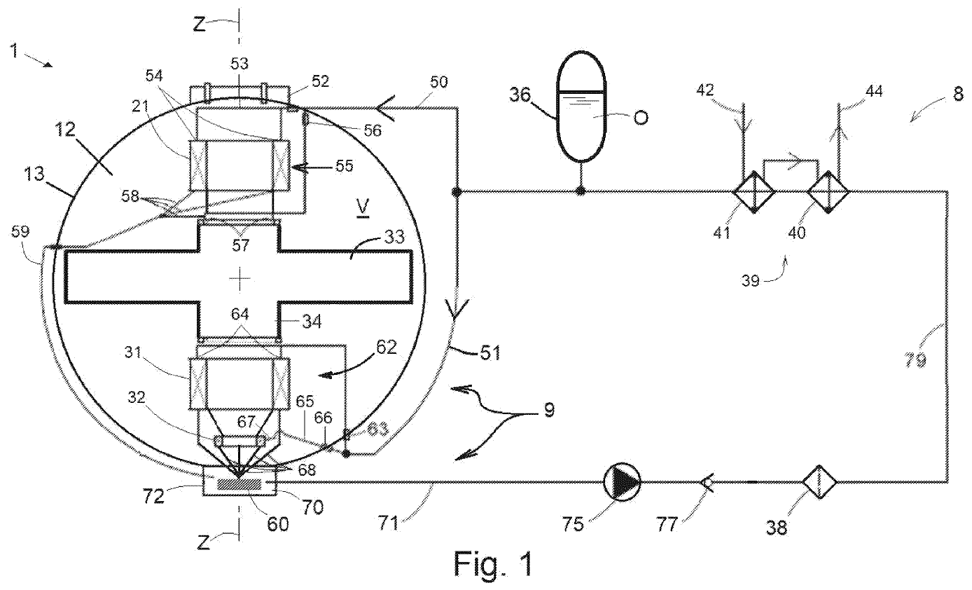

With reference to FIG. 1 of the drawings, a gyrostabiliser assembly 1 according to a preferred embodiment is illustrated diagrammatically. The gyrostabiliser assembly 1 includes a housing 13 that encloses a chamber 12 for supporting a partial vacuum V (e.g., in the range of about 1 to 100 mbar) as an operating pressure, and a flywheel 33 that is integral with or fixed on a generally vertically oriented flywheel shaft 34 which is mounted within the vacuum chamber 12 for rotation at the operating pressure about a generally vertical spin axis or rotational axis Z. The flywheel shaft 34, upon which the flywheel 33 is fixed and supported, is mounted in the housing 13 via upper and lower rotary bearings 21, 31 (also referred to as “spin bearings”) located at opposite end regions of the shaft 34 for rotation of the flywheel 33 about the spin axis Z, as well as via a lower thrust bearing 32. The flywheel 33 may be integral with the shaft 34 or may be attached to it. In this embodiment, the upper and lower bearings 21, 31 are in the form of rolling-element bearings with rolling elements (e.g., steel balls or rollers) held and movable between an inner race securely fixed to the shaft 34 and an outer race securely fixed to the housing 13. The generally vertical orientation of the flywheel shaft 34 and spin axis Z allows the housing 13 to be set up or mounted as a pendulum about a generally horizontal axis with a natural point of stability near vertical. As a result, no mechanism is needed to ensure that a precession angle of the gyroscope assembly 1 remains centred around a mid-stroke. The gyroscope assembly 1 includes an electric drive motor or spin motor 52 for driving rotation of the flywheel 33 about the spin axis Z and the electric motor 52 is mounted on the housing 13 and is operatively coupled to the flywheel shaft 34 via a magnetic coupling 53.

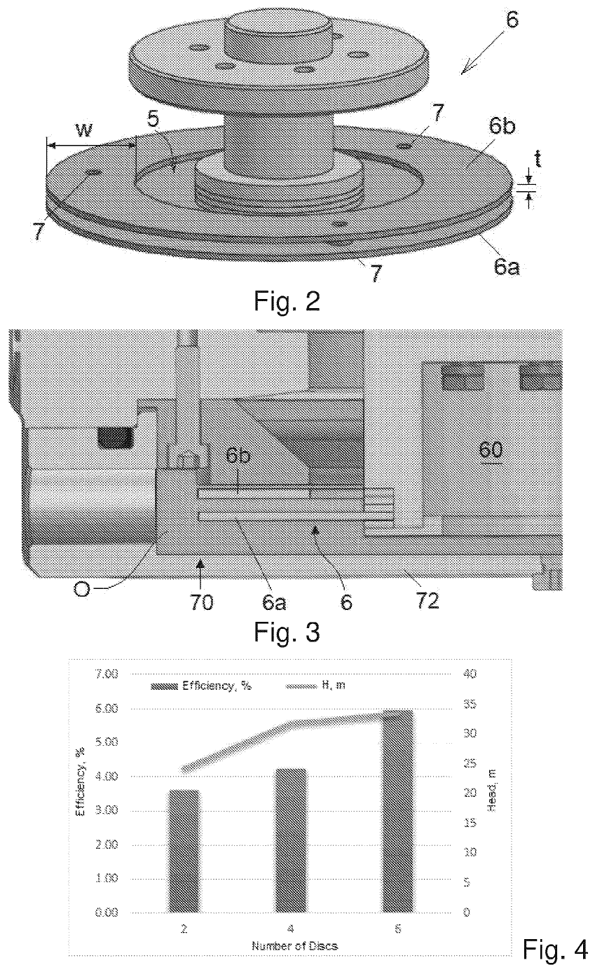

The gyrostabiliser assembly 1 further includes a lubrication system 8 (oil-based) for the upper and lower spin bearings 21, 31 configured to circulate oil O to each of the bearings 21, 31 from an oil sump or reservoir 70. The lubrication system 8 thus includes an oil circuit 9 comprising a series of interconnected lines or conduits 71, 79, 50, 51, 58, 59, 65 via which the oil O is circulated from the sump or reservoir 70 to the respective spin/thrust bearings 21, 31, 32 and then back to the reservoir 70. To this end, the lines or conduits 71, 79, 50, 51, 65 of the oil circuit 9 may be both (i.e., partially) external to and (partially) within the housing 13 through which the oil O is delivered or supplied to each of the spin or thrust bearings 21, 31, 32 from the oil reservoir 70. The upper and lower spin bearings 21, 31 are configured and arranged in the housing 13 such that the oil O circulated or delivered to the spin bearings 21, 31 drains out of each respective bearing 21, 31 for return to the sump or reservoir 70 under gravity. In this connection, the lubrication system 8 includes at least one pump 60 in the sump or reservoir 70 that is coupled to and driven by the flywheel shaft 34 for circulating the lubricant oil O via the oil circuit 9 to the first and second spin bearings 21, 31. The pump 60 comprises a rotary disc pump, which is a kind of centrifugal pump with an impeller 6 as shown in FIGS. 2 and 3. The impeller 6 comprises two substantially flat discs 6a, 6b, one disc 6a being of a generally solid circular shape and the other disc 6b generally annular or ring shaped, mounted coaxially in spaced apart, generally parallel arrangement with respect to one another by threaded stems, bolts, or other fasteners 7, with a spacing between the discs of about 0.5 mm. These stems or bolts 7 interconnecting the discs 6a, 6b of the impeller 6 have an elliptical cross-sectional profile (e.g., in a ratio of 1:2) for a low profile in a direction of rotation of the impeller 6 (i.e., with the shorter elliptical dimension parallel to the disc radius). The flat annular disc 6b has a central aperture 5 for passage of oil into the space between the discs 6a, 6b and substantially the same outer diameter as the solid circular disc 6a. The radial width w of the annular disc 6b is about 25% of the outer diameter (120 mm) of the disc. Thus, the central aperture 5 of the annular disc has a diameter that is about 50% of the outer diameter of the disc 6b. The thickness t of each disc 6a, 6b is preferably in a range of about 0.5 mm to 2.0 mm. The impeller 6 is without vanes and, when rotated, utilises the principles of boundary layer and viscous drag to impel the oil O from the sump or reservoir 70 along the lubricant circuit 9. As the impeller 6 of the rotary disc pump 60 is designed without vanes it can be rotated at high speed with substantially laminar flow of the lubricant and without generating significant vibration or cavitation. In this way, the impeller 6 of the rotary disc pump 60 may be rotated with the gyro flywheel shaft 34 at speeds in the range of about 3,000 rpm to about 10,000 rpm. Due to the low hydro-dynamic resistance of the impeller 6, the pump 60 does not require gearing and the high rotational speeds do not create any significant cavitation effects in the oil.

With reference to FIG. 4 of the drawings, it will be noted that the pump 60 may have an impeller 6 with a plurality of axially aligned annular discs 6b in a stacked array above the solid disc 6a, and uniformly spaced apart in relation to each other and to the solid disc 6a. The central opening 5 in each of the annular discs 6b is also substantially uniform and again allows central passage of the oil O into the impeller 6 and into the space between each of the discs 6a, 6b. For example, the impeller may include two, three, four or five annular discs 6b mounted in a stacked array in combination with a solid disc 6a. As seen in FIG. 4, the pressure head generated by the pump 60 as well as its efficiency can be significantly improved by increasing the number of rotary discs 6a, 6b, although the improvements tend to become smaller once the number of discs exceeds five. FIG. 4 illustrates the disc pump efficiency and pressure head for synthetic (polyalphaolefin) oil O at 80 °C at 7 l/min flow rate, with the computational fluid dynamics (CFD) results being calculated for pump inlet pressure 30 mbar, disc diameter of 120 mm, and a shaft speed 4800 rpm.

The rotary disc pump 60 thus operates for circulating or delivering the oil from the reservoir 70 to the upper and lower bearings 21, 31. The vertical orientation of the spin axis Z means that oil O supplied to the upper and lower bearings 21, 31 is directed naturally to the sump or reservoir 70 via gravity. That is, the sump or reservoir 70 is located at a base of the housing 13 below the vacuum chamber 12 to collect the oil via return lines or channels 58, 59, 68 from the upper and lower spin bearings 21, 31 and thrust bearing 32 under gravity, with the bearings 21, 31, 32 provided in the housing 13 at the operating pressure V. In this way, the vacuum chamber 12 is a single chamber operating at one pressure V. This not only reduces aerodynamic drag on the flywheel 33, thereby reducing both the power required to maintain flywheel speed (rpm) and heat generated by air resistance to the spinning flywheel 33, but also provides for a simpler design of the gyrostabiliser assembly 1 in which rotary shaft seals for isolating the upper and lower spin bearings 21, 31 from the operating pressure V of the flywheel chamber 12 are not required. This simpler configuration of the gyrostabiliser assembly 1 can, in turn, facilitate the production of the gyrostabiliser assembly 1 on a smaller scale.

Referring to FIG. 1, the lubricant circuit 9 includes a further pump 75 external to the housing 13 and vacuum chamber 12 which is provided as a start-up, shutdown, and pressure boost pump. In this way, this further pump 75 may be employed to generate oil pressure in the lubricant circuit 9 before the flywheel 33 and flywheel shaft 34 have commenced operation (i.e., before the rotary disc pump 60 is operational). This pump 75 may also operate to boost the oil pressure in the lines or conduits 71, 79, 50, 51 for improved oil delivery to the bearings 21, 31 when the rotary disc pump 60 is operating. This external pump 75 may, for example, be a vaned centrifugal pump and it may be magnetically coupled to a brushless electrical motor. From the pump 75, the oil flows in the oil circuit 9 through a check valve 77 and through a filter 38, with the oil O passing via conduit 79 to an oil cooler 39. The oil cooler 39 is shown as two heat exchanger units 40, 41 in series with coolant supplied or flowing in through a line or conduit 42 and out through a line or conduit 44. Oil exits the cooler 39 and flows to an oil accumulator 36, which stores the oil O and maintains the oil pressure in order to cushion fluctuations in the oil pressure from the pumps 60, 75. The oil pressure maintained by the oil accumulator in the oil circuit 9 is preferably in the range of about 1.5 bar to about 3 bar (absolute pressure). The check valve (i.e., non-return valve) 77 located upstream of the oil accumulator 36 avoids back-pressure from the accumulator 36 being exertion on the sump or reservoir 70. The oil accumulator 36 can thus support the oil jetting pressure at the bearings 21, 31, 32 for oil splashing conditions at the pump 60 and/or when oil supply may be absent at the inlet to the sump pump 60 for a period of time—e.g., when the gyrostabiliser 1 experiences an extended period at a high precession angle (e.g., at about 70°) during a U-turn of the vessel. The oil accumulator 36 is preferably a bladder- or piston-type oil accumulator. Downstream of the accumulator 36, the oil flow is then split between a conduit 50 towards the upper spin bearing 21 and a conduit 51 towards the lower spin bearing 31 as well as to the thrust bearing 32. It will be appreciated that the accumulator 36 can be located anywhere along the oil circuit 9 between the pump 75 and the split in lines to the two conduits 50, 51.

The oil lubrication system 8 includes one or more oil-jetting outlets 54, 64, 67 at each of the upper and lower spin bearings 21, 31 and thrust bearing 32 for targeted delivery or injection of the oil O via the oil circuit 9. The oil flowrate is selected to provide a desired exchange of heat generated at the bearings 21, 31, 32 into the oil. The oil lubrication system 8 therefore also forms a cooling system for the bearings 21, 31, 32 in which the oil acts as a coolant to carry heat away from the bearings. In particular, the oil injection via jetting outlets 54, 64 ensures that oil O is targeted at the rolling elements in the rotary bearings 21, 31 with sufficient velocity and pressure that it mixes with the boundary layer oil for effective lubrication as well as a cooling effect. To this end, the oil circuit 9 includes the heat exchangers 40, 41 for removing heat from the oil before the oil O is delivered to the upper and lower bearings 21, 31. In this regard, walls 72 of the sump or reservoir 70 may form or act as a heat exchanger for the oil O, optionally via a cooling medium provided in the walls 72 (e.g. in the manner of a water jacket) and/or via fin elements (not shown) formed in the walls, as the oil returns to the reservoir 70 under gravity. As noted above, the oil circuit 9 includes at least one filter 38 for filtering the oil O prior to its re-injection at the jetting outlets 54, 64, 67.

With further reference to FIG. 1 of the drawings, it will be seen that the upper and lower bearings 21, 31 have oil labyrinths 55, 62 provided around them to prevent the oil O applied to the bearings 21, 31 from flowing where it should not, such as onto the flywheel 33 or onto the thrust bearing 32, which is separately cooled via the line 65 and jetting nozzle 67. These oil labyrinths 55, 62 direct the flow of the oil to the sump or reservoir 70 via the return lines or channels 58, 59, 68. As noted above, the sump or reservoir 70 is arranged in or on the housing so that the oil supplied, circulated, or delivered to the first and second spin bearings 21, 31 and thrust bearing 32 drains out of each respective bearing 21, 31, 32 via the respective oil labyrinth 55, 62 for return to the reservoir 70 under gravity. The oil is desirably a synthetic oil with a vapour pressure less than 40 mbar at 80 °C.

The following tests were carried out using the rotary disc pump operating in a rough vacuum either alone or in combination with a vaned boost pump:
Test 1: Rotary disc pump 60 running at 4800 rpm in rough vacuum. A rotary disc pump (vaneless/bladeless) has been tested pumping up to 6.7 l/min synthetic polyalphaolefin oil with an absolute inlet pressure of 32 mbar, delivering 1.3 bar outlet pressure with the oil temperature at 65 °C.
Test 2: Rotary disc pump 60 running at 4800 rpm in rough vacuum in combination with a vaned boost pump or supply pump 75. The closed rotary disk pump was connected in series with a vaned boost pump during testing and pumped up to 11.8 l/min synthetic (polyalphaolefin) oil with absolute inlet pressure of 37 mbar, delivering 1.1 bar absolute pressure at the disc pump outlet and 3.2 bar absolute pressure at the vane pump outlet for the oil temperature 74 °C.
Test 3: Rotary disc pump 60 running at 3000 rpm in rough vacuum in combination with a vaned boost pump 75. The closed rotary disc pump was in series connected with a vaned boost pump during testing and pumped up to 9.5 l/min synthetic (polyalphaolefin) oil for absolute inlet pressure of 14 mbar, delivering 0.6 bar absolute pressure at the disc pump outlet and 3.1 bar absolute pressure at the vane pump outlet for the oil temperature 69 °C.
Test 4: Rotary disc pump 60 running at 4800 rpm at low pressure and combined with a vaned boost pump 75 (mixed flow air-oil). The closed rotary disc pump was connected in series with a vaned boost pump during testing and pumped up to 11.7 l/min synthetic (polyalphaolefin) oil with an absolute inlet pressure of 332 mbar, and delivered 1.0 bar absolute pressure at the disc pump outlet and 3.1 bar absolute pressure at the vaned pump outlet for the oil temperature 70 deg C.

Advantages of the rotary disc pump include that: it can run dry without damage, it is operable at higher temperatures, it benefits from a higher viscosity fluid; it generates substantially laminar flow with essentially no cavitation in a vacuum; it requires little maintenance; it is inexpensive to produce; it has a low height profile; it requires no running-in period; it can pump a gas-liquid mixture; it is suitable to run at high rpm; and it does not impede start-up pump operation.

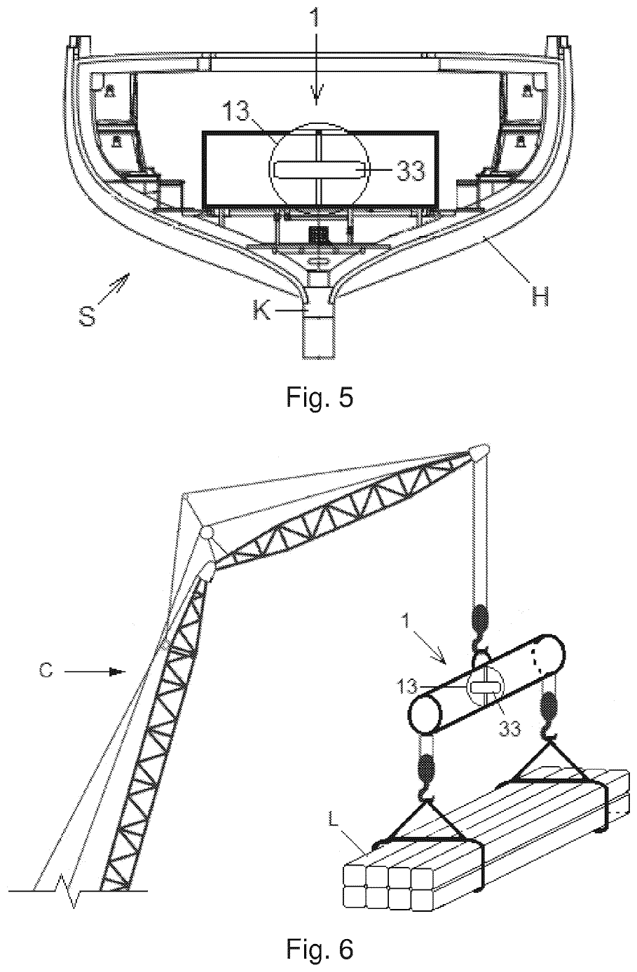

Referring to FIG. 5 of the drawings, a marine vessel S, such as a ship, yacht, or boat, is shown including a gyrostabiliser assembly 1 according to an embodiment of the disclosure described above. The gyrostabiliser assembly 1 is securely fixed to a hull H of the vessel S adjacent a keel K.

With reference to FIG. 6 of the drawings, a hoisting system, such as a crane C, is shown, including a gyrostabiliser assembly 1 according to an embodiment of the disclosure as described above. In this context, the gyrostabiliser assembly 1 is designed to be suspended from the hoisting system operating to dampen or suppress undesirable oscillatory rotation, e.g., caused by wind gusts, of a suspended load L during a hoisting operation. A gyrostabiliser assembly 1 is provided for, and/or mounted along, each axis of required stabilisation.

Although specific embodiments of the invention are illustrated and described herein, it will be appreciated by persons of ordinary skill in the art that a variety of alternative and/or equivalent implementations exist. It should be appreciated that each exemplary embodiment is an example only and is not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

Generally, the present disclosure is intended to cover any and all adaptations or variations of the specific embodiments discussed herein. By way of example, a skilled person will readily appreciate that the gyrostabiliser assembly 1 and the systems of this disclosure are not limited to being made from any particular material described in the specific embodiments. Rather, the skilled person will appreciate that a range of suitable materials exist, and the skilled person can readily select a suitable material based upon the known mechanical properties of that material which make it suitable for use in this disclosure. As the present disclosure involves engineering technology from a number of disciplines, it is expected that the notional ‘skilled person’ may comprise a group or a team of individuals having technical expertise and/or qualifications in one or more of the fields or disciplines including mechanical engineering, marine engineering and hydraulic engineering.

It will also be appreciated that the terms “comprise”, “comprising”, “include”, “including”, “contain”, “containing”, “have”, “having”, and variations thereof used in this document are, unless the context indicates otherwise, intended to be understood in an inclusive (i.e. non-exclusive) sense, such that the process, method, device, apparatus, or system described herein is not limited to those features, integers, parts, elements, or steps recited but may include other features, integers, parts, elements, or steps not expressly listed and/or inherent to such process, method, device, apparatus, or system. Further, the terms “a” and “an” used herein are intended to be understood as meaning one or more unless explicitly stated otherwise. Moreover, the terms “first”, “second”, “third” etc. are used merely as labels and are not intended to impose any numerical requirements on or to establish any ranking of importance of their objects. In addition, reference to positional terms, such as “lower” and “upper”, used in the above description are to be taken in context of the embodiments depicted in the figures, and are not to be taken as limiting the invention to the literal interpretation of the term but rather as would be understood by the skilled addressee in the appropriate context.

Reference signs

| | |
|---|---|
| 1 | gyrostabiliser assembly |
| 5 | central aperture |
| 6 | impeller |
| 6a | solid flat disc |
| 6b | annular or ring shaped disc |
| 7 | stem, bolt, or fastener |
| 8 | lubrication system |
| 9 | oil circuit |
| 12 | vacuum chamber |
| 13 | housing |
| 21 | upper bearing |
| 31 | lower bearing |
| 32 | thrust bearing |
| 33 | flywheel |
| 34 | flywheel shaft |
| 36 | oil accumulator |
| 38 | filter |
| 39 | oil cooler |
| 40 | heat exchanger |
| 41 | heat exchanger |
| 42 | coolant supply line |
| 44 | coolant supply line |
| 50 | oil supply line |
| 51 | oil supply line |
| 52 | electric motor |
| 53 | magnetic coupling |
| 54 | oil jetting outlet |
| 55 | oil labyrinth |
| 58 | lubricant return channel |
| 59 | lubricant return channel |
| 60 | pump means |
| 62 | oil labyrinth |
| 64 | oil jetting outlet |
| 65 | oil supply line |
| 67 | oil jetting outlet |
| 68 | lubricant return line or channel |
| 70 | sump or reservoir |
| 71 | oil supply line |
| 72 | wall of sump/reservoir |
| 75 | positive displacement pump |
| 77 | check valve |
| 79 | oil supply line |
| Z | rotational axis or spin axis of shaft |
| V | partial vacuum |
| O | lubricant/oil |
| w | radial width of annular disc |
| t | thickness of annular disc |
| S | marine vessel or ship |
| H | hull |
| K | keel |
| C | hoisting system or crane |
| L | load |

1. A gyrostabiliser assembly comprising:
a housing defining a chamber for supporting an operating pressure;
a flywheel mounted within the chamber for rotation about a spin axis at the operating pressure;
a flywheel shaft upon which the flywheel is mounted in the housing, the flywheel shaft supported by a first spin bearing and second spin bearing located at opposite end regions of the shaft for rotation of the flywheel about the spin axis, wherein the first and second spin bearings are arranged in the housing at, or for use at, the operating pressure; and
a bearing lubrication system comprising a lubricant circuit for circulating a liquid lubricant to the first and second spin bearings from a lubricant sump or reservoir that is located or arranged to collect the liquid lubricant from the first and second spin bearings under gravity,
wherein the bearing lubrication system includes a rotary disc pump in the sump or reservoir that is coupled to or driven by the flywheel shaft for circulating the lubricant via the lubricant circuit to the first and second spin bearings.

2. The gyrostabiliser assembly according to claim 1, wherein an impeller of the rotary disc pump is rotated by the flywheel shaft at speeds in the range of about 3,000 rpm to about 10,000 rpm.

3. The gyrostabiliser assembly according to claim 1, wherein the rotary disc pump is arranged within the sump or reservoir submerged in the lubricant.

4. The gyrostabiliser assembly according to claim 1, wherein an impeller of the rotary disc pump comprises at least two substantially plain or flat discs mounted in an axially aligned and generally parallel arrangement with respect to one another, wherein the at least two substantially plain or flat discs include a first solid disc and a second annular disc of substantially a same outer diameter as the first disc.

5. The gyrostabiliser assembly according to claim 1, wherein the rotary disc pump coupled to or driven by the flywheel shaft forms a first stage of a two-stage pump arrangement provided in the sump or reservoir, and wherein a centrifugal pump with a vaned impeller forms a second stage.

6. The gyrostabiliser assembly according to claim 1, wherein the liquid lubricant is oil, and wherein the oil prefer-ay has a vapour pressure less than 40 mbar at 80 °C.

7. The gyrostabiliser assembly according to claim 1, wherein the lubricant circuit outside the housing includes an oil accumulator for storing liquid lubricant and maintaining pressure of the lubricant.

8. The gyrostabiliser assembly according to claim 1, wherein the lubricant circuit, via which the lubricant is circulated from the sump or reservoir to the bearings and back includes a positive displacement pump external to the housing chamber as a start-up, shutdown, and pressure boost pump.

9. The gyrostabiliser assembly according to claim 1, wherein the first and second spin bearings have lubricant labyrinths around them to prevent the lubricant applied to the first and second spin bearings from flowing onto the flywheel; wherein the lubricant labyrinths are adapted to redirect the lubricant to the sump or reservoir via channels.

10. The gyrostabiliser assembly according to claim 1, wherein the lubrication system includes a jetting outlet, for targeted delivery or injection of the lubricant at each of the first and second spin bearings.

11. The gyrostabiliser assembly according to claim 1, wherein the first and second spin bearings are configured and arranged within the housing such that lubricant circulated to the first and second spin bearings drains out of each respective spin bearing for return to the sump or reservoir under gravity.

12. The gyrostabiliser assembly according to claim 1, wherein the flywheel shaft is mounted in an essentially vertical orientation within the housing for rotation about an essentially vertical spin axis, wherein the first and second spin bearings comprise an upper spin bearing and a lower spin bearing, respectively.

13. The gyrostabiliser assembly according to claim 1, comprising an electric motor for driving rotation of the flywheel about the spin axis, wherein the electric motor is mounted outside of the housing chamber and is coupled to the flywheel shaft via a magnetic coupling.

14. The gyrostabiliser assembly according to claim 1, wherein the operating pressure is a partial vacuum or rough vacuum in a range of about 1 mbar to 100 mbar absolute pressure such that the chamber in which the flywheel is mounted forms a vacuum chamber.

15. A gyrostabiliser assembly for a marine vessel comprising: a housing defining a chamber for supporting at least a partial vacuum; a flywheel mounted within the chamber for rotation about a spin axis at the partial vacuum; a flywheel shaft upon which the flywheel is mounted in the housing for rotation of the flywheel about the spin axis, the flywheel shaft rotatably supported by a first bearing at one end region of the shaft and a second bearing at an opposite end region of the shaft, with the first and second bearings being arranged in the housing to operate under the partial vacuum; and a bearing lubrication system configured to supply oil to the first and second bearings from an oil reservoir via an oil circuit, the reservoir being arranged in or on the housing to collect oil from the first and second bearings under gravity, wherein the lubrication system includes a rotary disc pump for pumping or circulating oil via the oil circuit.

16. The gyrostabiliser assembly according to claim 15, wherein the rotary disc pump in the reservoir is coupled to and driven by the flywheel shaft.

17. The gyrostabiliser assembly according to claim 15, wherein the rotary disc pump is separate from the flywheel shaft and driven by an electric motor.

18. The gyrostabiliser assembly according to claim 15, wherein the rotary disc pump comprises two substantially flat discs mounted in a spaced, generally parallel arrangement with respect to one another including a first solid flat disc and a second, axially aligned annular flat disc of the same outer diameter as the first disc.

19. A marine vessel comprising a boat or motor yacht, the marine vessel comprising the gyrostabiliser assembly according to claim 1, wherein the gyrostabiliser assembly is secured to a hull of the vessel.

20. A hoisting system comprising the gyrostabiliser assembly according to claim 1, wherein the gyrostabiliser assembly is adapted to be suspended with a load from the hoisting system.

21. A gyrostabiliser assembly comprising:
a housing defining a chamber for supporting an operating pressure;
a flywheel mounted within the chamber for rotation about a spin axis at the operating pressure;
a flywheel shaft upon which the flywheel is mounted in the housing, the flywheel shaft supported by a first spin bearing and second spin bearing located at opposite end regions of the shaft for rotation of the flywheel about the spin axis, wherein the first and second spin bearings are arranged in the housing at, or for use at, the operating pressure; and
a bearing lubrication system comprising a lubricant circuit for circulating a liquid lubricant to the first and second spin bearings from a lubricant sump or reservoir that is located or arranged to collect the liquid lubricant from the first and second spin bearings under gravity,
wherein the bearing lubrication system includes a pump means provided in the sump or reservoir that is coupled to and driven by the flywheel shaft for circulating the lubricant via the lubricant circuit to the first and second bearings.

22. The gyrostabiliser assembly according to claim 21, wherein the pump means in the sump or reservoir comprises a rotary disc pump, and wherein an impeller of the rotary disc pump is rotated by the flywheel shaft at speeds in the range of about 3,000 rpm to about 10,000 rpm.

23. The gyrostabiliser assembly according to claim 22, wherein the rotary disc pump is arranged within the sump or reservoir submerged in the lubricant.

24. The gyrostabiliser assembly according to claim 21, wherein the pump means provided in the sump or reservoir comprises a two-stage pump arrangement, wherein a rotary disc pump coupled to and driven by the flywheel shaft forms a first stage, and wherein a centrifugal pump with a vaned impeller forms a second stage.

25. The gyrostabiliser assembly according to claim 21, wherein the liquid lubricant is oil, and wherein the oil has a vapour pressure less than 40 mbar at 80 °C.

26. The gyrostabiliser assembly according to claim 22, wherein the impeller includes a plurality of discs mounted in an axially aligned and generally parallel arrangement with respect to one another.

27. The gyrostabiliser assembly according to claim 22, wherein an outer diameter of each disc of the impeller is within a range of about 100 mm to about 200 mm.

28. The gyrostabiliser assembly according to claim 22, wherein a radial width of each annular disc is in a range of about 20% to about 40% of an outer diameter of the annular disc.
